(19) United States
(12) Patent Application Publication
(10) Pub. No.: US 2015/0107866 A1
(43) Pub. Date: Apr. 23, 2015

(54) LIGHT WEIGHT CABLE

(71) Applicant: NEXANS, Paris (FR)

(72) Inventors: Michael Lee, Tottenham (AU); Kenneth Willis Barber, South Yarra (AU)

(21) Appl. No.: 14/384,424

(22) PCT Filed: Apr. 24, 2013
(86) PCT No.: PCT/IB2013/000999

§ 371 Date: Sep. 11, 2014

(30) Foreign Application Priority Data
May 2, 2012 (AU) 2012901996
Jun. 26, 2012 (AU) 2012902711

(51) Int. Cl. H01B 9/00; H01B 7/02; H01B 3/30; H01B 7/17; H01B 1/02

(52) U.S. Cl. CPC H01B 9/008; H01B 7/17; H01B 1/023; H01B 3/30; H01B 7/0275
USPC 174/6; 174/110 R; 174/40 R

(57) ABSTRACT

A cable adapted for suspension between poles in a single wire earth return application is composed of three elements; a core 2.030; a conductive layer 2.032 around the core, and a jacket 2.034 over the conductive layer. The core has high tensile strength to weight ratio and can be made of a composite material such as carbon fibre and epoxy. The conductive material can be aluminium. The jacket can be made from a material having electrical insulating properties. The conductive layer can be formed as a loose tube (7.072) around the core and drawn down to contact the outer surface of the core.

### FIELD OF THE INVENTION

This invention relates to electrical cables.

The invention is particularly suited for suspended power cables.

### BACKGROUND OF THE INVENTION

The invention will be described in the context of a cable for use in a single wire earth return (SWER) electricity supply system such as may be used, for example, in a rural environment in which consumers are widely separated. The line voltage can be between about 11 KV and 33 KV. In Australia, 22 KV is commonly used.

In some countries, such as Australia, much of the rural electricity supply is by Single Wire Earth Return (SWER) conductor systems or Single or two phases. SWER is a high voltage single phase distribution system using only one overhead line conductor; the circuit is completed through earth connections (much like the wiring in a car using the body and chassis as a return path to the battery “earth”).

Such systems are difficult to adequately protect due to the high “impedance/resistance” of the circuit and earthing arrangements. If the line breaks and falls to the ground or if a tree should touch the line then sparks may occur before the circuit protection systems operate. This can start bush fires and with the risk of loss of life and property damage.

Many of the SWER Lines are made with long spans using small aluminium conductor-steel reinforced conductors. One current design includes three steel wires with an aluminium cladding over each wire, each wire having a diameter of 2.75 mm (3*2.75 mm). Often, the spans can be of the order of 400 m, and spans of about 1000 m can be used for inclined topographies.

Putting the supply underground would solve the problem but this is too expensive in most cases particularly as the voltage to earth is either 12.7 kV or 19 kV. Using conventional HV aerial bundled cable (ABC) would also be too costly and require more poles.

An alternative is to replace the bare conductors with “covered” conductors “CC”. However this cannot in many cases be done with conventional materials and conductor designs using Aluminium Clad Steel wires or composite steel and aluminium because the added weight of the insulation material will cause too much sag if existing poles are used because the required cable tension would exceed the permitted load of the poles. Restricting the tension to within the permitted pole load would result in excessive sag.

A cable suspended between two poles at the same height approximately forms a symmetrical catenary curve. Where the suspension points are at different heights, the curve is asymmetric. The amount of sag of a catenary depends on the length of cable between the suspension points, and this is related to the tension applied to the cable. This property can be used to mathematically calculate the sag of a cable between two poles. The weight per unit length of the cable is one factor which contributes to the tension, and the tension applied to the cable when it is erected is a major factor. In order to reduce the likelihood of a suspended cable deflecting excessively in high winds, it is desirable to reduce the sag of the cable.

Most recent development in aerial power cables has been in the field of high power, high current transmission lines in power distribution networks, where a substantial capital expenditure on the distribution lines is justified.

The PCT specification of WO2003050825 discloses a high power cable suitable for transmission of electrical power from power generating stations. This cable is formed from composite-composite wires, each composite-composite wire having individual strands of a conducting material such as aluminium or copper with one or more cores of carbon fibre or ceramic fibre reinforced composite wire. The composite core wire comprises aligned reinforcing fibres of carbon or ceramic embedded in a matrix material. The matrix may be conducting material such as aluminium or copper, or it may be a polymer applied in a pressurized molten bath to infiltrate between the composite wires. An insulating layer is then applied to the exterior of the cable. Such a cable involves complex manufacturing processes and would be prohibitively expensive for use as a SWER cable.

EP1089299 (A2) discloses a twisted and compressed conductor comprising a central wire and a plurality of conductor wires concentrically twisted around the central wire, wherein the central wire is at least one high-strength wire made of a fibre-reinforced metal matrix composite. Such a cable is not suitable for SWER applications.

Similarly, WO2005082556 discloses a method of manufacturing metal clad metal matrix composite wires. A metal matrix composite wire comprises a plurality of fibres in a conductive metal matrix. The specification states that it is desirable to increase the uniformity of the wires to improve the uniformity of packing the wires in a cable. The metal matrix composite wire has poor uniformity, and the cladding is applied to compensate for. The ductility of the cladding is also said to reduce failure due to micro-buckling. The specification does not suggest that the cladding is applied as the primary or sole conductor. A cladding machine applies a metal cladding over each wire. A plurality of such wires can be wound together to provide a non-insulated power transmission line. The cladding are chosen for their ductility and compatibility with the metal matrix components, and can be selected from aluminium, zinc, tin, magnesium, copper and alloys of these. Again, such a cable is not suitable for SWER applications.

U.S. Pat. No. 6,528,729 (B1) discloses a flexible conductor having a core material composed of a plurality of twisted reinforcing fibres at the centre of the conductor, and a metal matrix therearound. The metal matrix has ceramic particles such as aluminium oxide dispersed in a metal such as copper or aluminium. An external jacket can be applied. The process of forming the metal matrix and applying it to the twister reinforcing fibres is complex and expensive.

U.S. Pat. No. 3,717,720 (A) discloses a glass fibre cable used as the tensile strength member of an overhead electrical transmission cable with the conductor wires being laid over the fibreglass cable as the core. An optional insulation jacket can also be applied. This cable requires a plurality of conductor wires to be wound onto the glass fibre core. The fibre glass core has a relatively large diameter.

It is desirable to provide a cable which can be used in suspended cable applications which addresses one or more of the disadvantages of the present cable designs.

### SUMMARY OF THE INVENTION

According to an embodiment of the invention, there is provided a light weight cable having a high strength to weight ratio, the cable including a central core, a conductive layer on the core, and an outer insulation layer.

The core can be a composite core.

The core can be a composite of a matrix material and light weight strength fibres.

The matrix material can be epoxy.

The fibres can be carbon fibres.

The fibres can be ceramic fibres.

The conductive layer is a tube the inner diameter of which is in contact with the outer surface of the core.

The conductive layer can be an aluminium layer or an alloy of aluminium.

The conductive layer can be copper or a copper alloy.

The outer jacket can be made from a material having electrical insulating properties.

The outer jacket layer can be high density polyethylene or cross-linked polymer.

The cable can have an outer diameter of about 13 mm or less.

The cable can have an outer diameter which is not greater than about 12 mm.

The cable can have an outer diameter which is greater than about 10 mm.

The core can have a diameter of between about 3 mm and about 8 mm.

The core diameter can be greater than or equal to about 3.5 mm and the less than or equal to about 7 mm.

The invention also provides a single line earth return line including a light weight having a high strength to weight ratio, the cable including a central core, a conductive layer on the core, and an outer insulation layer.

The invention also provides a single line earth return line including a light weight having a high strength to weight ratio, the cable including a central core, a conductive layer on the core, and an outer insulation layer.

The invention further provides a method of manufacturing a high strength, light weight cable, the method including the steps of applying a layer of conductive material to the exterior of a core, and applying a jacket over the layer of conductive material.

The step of applying a layer of conductive material can include the step of wrapping a tape of conductive material around the core.

The longitudinal sides of the tape can be joined.

The longitudinal sides of the tape can be welded.

The wrapped tape can form a loose tube around the core.

The loose tube can be drawn down to contact the outer surface of the core.

The method can include the steps of bonding the longitudinal sides of the tape together after the tape is wrapped around the core to form a loose tube around the core, and drawing the loose tube down to the outer surface of the core.

In an alternative method, the method of forming the cable can include the steps of forming a tube of conductive material around the core in a continuous forming process.

The tube can be formed as a loose tube and drawn down to contact the outer surface of the core.

In one embodiment, the invention also provides a SWER cable having a core, a conductive layer applied to the outer surface of the core, and a jacket over the conductive layer.

Preferably the cable can achieve the same or greater span between two poles compared to known SWER line: the span is a function of weight/strength; thermal elongation; and wind loading. The cable can be designed to be installed on existing SWER poles.

### BRIEF DESCRIPTION OF THE DRAWINGS

An embodiment or embodiments of the present invention will now be described, by way of example only, with reference to the accompanying drawings, in which:

FIG. 1 is a schematic illustration of an electricity distribution system including a SWER line;

FIG. 2 illustrates a stripped back segment of a cable according to an embodiment of the invention;

FIG. 3 is an end view of a section of a cable according to an embodiment of the invention;

FIG. 4 is a section view of a cable termination for a cable according to an embodiment of the invention;

FIG. 5 is a section view of an electrical connection for a cable according to an embodiment of the invention.

FIG. 6 is a schematic illustration of a first production line for implementing a method of manufacturing a cable according to an embodiment of the invention.

FIG. 7A is a schematic illustration of a second production line for implementing a method of manufacturing a cable according to an alternative embodiment of the invention.

FIG. 7B is an illustration of an alternative production line for manufacturing a cable according to an embodiment of the invention.

FIG. 8 is a flow diagram illustrating the main stages of the process of manufacturing a cable according to an embodiment of the invention.

FIG. 9 is a flow diagram illustrating one embodiment of the stage of forming of the conductive layer of FIG. 8.

The numbering convention used in the drawings is that the digits in front of the full stop indicate the drawing number, and the digits after the full stop are the element reference numbers. Where possible, the same element reference number is used in different drawings to indicate corresponding elements.

The orientation of the drawings may be chosen to illustrate features of the embodiment of the invention, and should not be considered as a limitation on the orientation of the invention in use.

It is understood that, unless indicated otherwise, the drawings are intended to be illustrative rather than exact representations, and are not necessarily drawn to scale. The orientation of the drawings is chosen to illustrate the features of the objects shown, and does not necessarily represent the orientation of the objects in use.

### DETAILED DESCRIPTION OF THE EMBODIMENT OR EMBODIMENTS

The invention will be described with reference to a single line earth return electric power supply line.

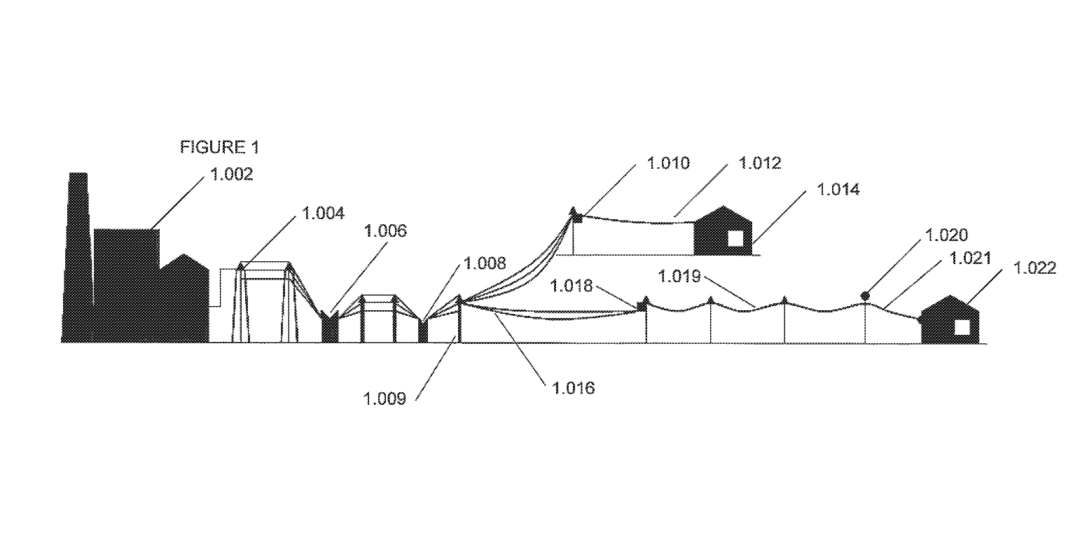

FIG. 1 illustrates an electric power distribution system delivering electricity from a generator 1.002 to consumers 1.014 and 1.022.

Alternating electricity, eg, 50 Hz in Australia, from generator 1.002 is delivered by 3 phase transmission lines 1.004 at a high voltage, eg, to a first transformer 1.006, which can be a stepping transformer to adjust the voltage to compensate for losses due to electricity demand current to maintain an approximately constant output voltage, eg, of the order of 66 kv. A step down transformer 1.008 reduces the voltage to an intermediate voltage, for example, 22 kv.

The 3 phase 22 kv line delivers electricity to a 3 phase step down transformer 1.010 which can supply either 3 phase or single phase electricity a number of consumers, of which 1.014, connected to line 1.012, is illustrative. In Australia, the domestic supply single phase is 240 v.

At pole 1.009, a single phase of the 22 kv line is taken off from the 3 phase line via 2 wire line 1.016. This single phase is connected to a SWER isolating transformer 1.018 which feeds the 22 kv single phase SWER supply line 1.019. A pole top transformer 1.020 reduces the voltage to 240 v for supply to consumer 1.022.

The 22 kv SWER cable 1.019 may be of a significant length, requiring a plurality of poles. It would be desirable to maximize the distance between the poles to reduce the cost of installation of the SWER line. In the rural environment, trees can be located in close proximity to the SWER line.

A cable suspended between two poles at the same height approximately forms a symmetrical catenary curve. Where the suspension points are at different heights, the curve is asymmetric. The amount of sag of a catenary depends on the length of cable between the suspension points, and this is related to the tension applied to the cable as well as the distance between the poles. This property can be used to mathematically calculate the sag of a cable between two poles. The weight per unit length of the cable is one factor which contributes to the tension, and the tension applied to the cable when it is erected is a major factor. In order to reduce the likelihood of a suspended cable deflecting excessively in high winds and contacting trees close to the line, it is desirable to reduce the sag of the cable. A limiting factor on the reduction of sag is the allowable tension which can be applied to the cable.

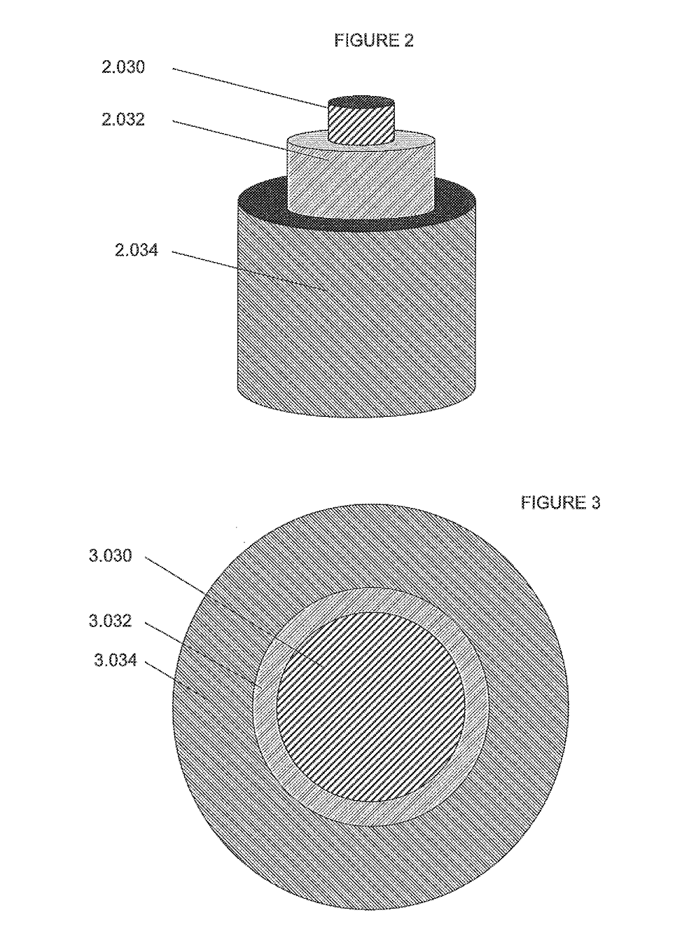

FIGS. 2 & 3 illustrate the construction of a cable according to an embodiment of the invention. The core 2.030, 3.030 is a strength member. A conductive layer 2.032, 3.032 is applied over the strength member. A protective outer layer 2.034, 3.034 can be applied to the exterior surface of the conductor layer.

The strength member can have a circular cross-section.

The conductor layer can be tubular.

The conductor layer can be aluminium.

The conductor can be a single unitary layer.

The provision of a single unitary layer for the conductor optimizes the packing factor of the conductor.

The formation of a conductive tube on the core protects the tube from collapse due to bending which may otherwise occur when winding the cable onto a spool or when the cable is being installed.

The conductivity of the cable can be adjusted by adjusting the cross-section of the conductor layer.

Wind loading which is a function of conductor diameter and shape of the conductor. The current 3 stranded wires having a higher drag coefficient than one smooth circular layer of the present invention.

Wind load is the main factor influencing the upper end of the range of the cable diameter, while the minimum cable diameter is determined by the minimum allowable dimensions of the core, the conductive layer and the external layer, in particular, the cable tension determines the minimum core diameter, the load current determines the minimum conductor cross section, and the voltage determines the jacket thickness. Preferably, the cable can have a diameter from about 5 mm to about 12 mm. The outside diameter of the cable is determined by the core diameter, the thickness of the conductive layer and the thickness of the external jacket.

The minimum diameter of the core is determined by the required strength or breaking load. For a SWER cable, the core diameter can be in the range of about 3 mm to about 7 mm. For a composite core having a composition of 47/53 fibre to epoxy, the core diameter can be from about 3.9 mm to about 5.6 mm.

The matrix material of the core can be chosen to meet the requirements of use in the SWER cable environment. The matrix can be compatible with, and adheres to, carbon fibre, and can have sufficient flexibility to allow the cable to be wound on a drum and to be handled during manufacture and installation. The matrix can be stable under the range of temperatures experienced by the cable in use. The matrix can be as described in our copending patent application WO2010/089500 and we have implemented the core using epoxy. Suitable epoxys include, for example, Huntsman Araldite GY281 bisphenol epoxy resin supplied by Huntsman, or SGL Carbon Group SIGRAFIL C® C39 T400 EPY supplied by SGL Carbon Group.

For short spans, the breaking load can be of the order of about 14.7 kN or more. For longer spans, the breaking load can be more than 22 kN. Preferably, the breaking load is about 30 kN or more.

The cross-sectional area of the conductor, for example aluminium, is primarily determined by the maximum current to be carried. The conductive layer can have a DC resistance of less than about 5 ohm/km, preferably, less than 4.8 ohm/km.

The exterior layer can be from about 1 mm thick to about 3 mm thick. Preferably, the external layer is between about 1.5 mm and about 2.5 mm. The exterior layer can be selected for characteristics such as abrasion resistance, weather resistance, UV resistance, and electrical insulation. For the exterior layer, we have found that polyethylene (PE), high density PE (HDPE), or cross-linked polyethylene (XLPE) are suitable. The thickness of the exterior layer or jacket can be chosen to reduce or eliminate electrical erosion when the cable comes into contact with a tree. The conductive material can have a thickness between about 0.3 mm and about 0.8 mm. Preferably the conductive layer has a thickness less than about 0.6 mm.

Additives, such as UV stabilizer, anti-tracking agents, fire retardant such as aluminium tri-hydride or magnesium hydrate can also be added, and high visibility colouring can be added to the jacket.

The Table illustrates the characteristics of a number of cable designs which may be used in SWER applications using a carbon fibre and epoxy core composition.

TABLE 1

| | | | | | | | | |
|---|---|---|---|---|---|---|---|---|
| Overall | | | | | | Youngs | | |
| diameter, | Core | | | Total | | Modulus | Coeff liner | |
| mm | diameter, | Al | XLPE | UTS, | Mass, | conductor | exp | DC |
| (5.9 min) | mm | thickness | thickness | kN | kg | GPa | conductor | Resistance |

CABLE PROPERTIES-PART A

| | | | | | | | | |
|---|---|---|---|---|---|---|---|---|
| 10.80 | 7.00 | 0.90 | 1.00 | 79.60 | 206.55 | 88.51 | 0.0000333 | 1.2686 |
| 12.80 | 7.00 | 0.90 | 2.00 | 80.34 | 241.77 | 63.24 | 0.0000468 | 1.2686 |
| 14.80 | 7.00 | 0.90 | 3.00 | 81.20 | 282.95 | 47.51 | 0.0000552 | 1.2686 |
| 8.80 | 5.00 | 0.90 | 1.00 | 41.26 | 128.01 | 74.13 | 0.0000392 | 1.6977 |
| 10.80 | 5.00 | 0.90 | 2.00 | 41.88 | 157.26 | 49.48 | 0.0000529 | 1.6977 |
| 12.80 | 5.00 | 0.90 | 3.00 | 42.62 | 192.48 | 35.46 | 0.0000607 | 1.6977 |
| 8.40 | 4.60 | 0.90 | 1.00 | 35.10 | 114.59 | 70.68 | 0.0000406 | 1.8210 |
| 10.40 | 4.60 | 0.90 | 2.00 | 35.69 | 142.65 | 46.39 | 0.0000543 | 1.8210 |
| 12.40 | 4.60 | 0.90 | 3.00 | 36.41 | 176.67 | 32.87 | 0.0000619 | 1.8210 |
| 10.20 | 7.00 | 0.60 | 1.00 | 78.84 | 183.13 | 92.45 | 0.0000333 | 1.9764 |
| 12.20 | 7.00 | 0.60 | 2.00 | 79.54 | 216.56 | 64.86 | 0.0000473 | 1.9764 |
| 14.20 | 7.00 | 0.60 | 3.00 | 80.37 | 255.95 | 48.09 | 0.0000559 | 1.9764 |
| 7.80 | 4.00 | 0.90 | 1.00 | 26.81 | 95.90 | 65.07 | 0.0000430 | 2.0435 |
| 9.80 | 4.00 | 0.90 | 2.00 | 27.36 | 122.17 | 41.51 | 0.0000565 | 2.0435 |
| 11.80 | 4.00 | 0.90 | 3.00 | 28.04 | 154.40 | 28.88 | 0.0000638 | 2.0435 |
| 10.44 | 5.00 | 0.72 | 2.00 | 41.49 | 145.00 | 49.92 | 0.0000535 | 2.1879 |
| 9.00 | 4.50 | 0.75 | 1.50 | 33.63 | 115.32 | 56.36 | 0.0000494 | 2.2883 |
| 10.04 | 4.60 | 0.72 | 2.00 | 35.33 | 131.00 | 46.68 | 0.0000550 | 2.3522 |
| 6.80 | 3.00 | 0.90 | 1.00 | 15.49 | 68.57 | 54.44 | 0.0000475 | 2.5665 |
| 8.80 | 3.00 | 0.90 | 2.00 | 15.98 | 91.85 | 32.83 | 0.0000606 | 2.5665 |
| 10.80 | 3.00 | 0.90 | 3.00 | 16.60 | 121.10 | 22.06 | 0.0000671 | 2.5665 |
| 8.20 | 5.00 | 0.60 | 1.00 | 40.67 | 109.68 | 77.34 | 0.0000396 | 2.6808 |
| 10.20 | 5.00 | 0.60 | 2.00 | 41.25 | 137.14 | 50.27 | 0.0000539 | 2.6808 |
| 12.20 | 5.00 | 0.60 | 3.00 | 41.95 | 170.56 | 35.38 | 0.0000618 | 2.6808 |
| 7.80 | 4.60 | 0.60 | 1.00 | 34.55 | 97.28 | 73.64 | 0.0000412 | 2.8867 |
| 9.80 | 4.60 | 0.60 | 2.00 | 35.10 | 123.55 | 46.94 | 0.0000554 | 2.8867 |
| 11.80 | 4.60 | 0.60 | 3.00 | 35.78 | 155.78 | 32.63 | 0.0000630 | 2.8867 |
| 7.20 | 4.00 | 0.60 | 1.00 | 26.30 | 80.12 | 67.55 | 0.0000438 | 3.2625 |

CABLE PROPERTIES-PART B

| | | | | | | | | |
|---|---|---|---|---|---|---|---|---|
| 9.20 | 4.00 | 0.60 | 2.00 | 26.82 | 104.59 | 41.68 | 0.0000578 | 3.2625 |
| 11.20 | 4.00 | 0.60 | 3.00 | 27.46 | 135.03 | 28.38 | 0.0000650 | 3.2625 |
| 8.44 | 3.00 | 0.72 | 2.00 | 15.70 | 82.65 | 32.43 | 0.0000616 | 3.3617 |
| 8.60 | 4.60 | 0.50 | 1.50 | 34.65 | 103.94 | 58.63 | 0.0000498 | 3.5359 |
| 9.03 | 5.12 | 0.46 | 1.50 | 42.54 | 117.80 | 63.63 | 0.0000478 | 3.5359 |
| 7.96 | 3.96 | 0.50 | 1.50 | 25.88 | 85.28 | 52.29 | 0.0000527 | 4.0401 |
| 8.40 | 4.50 | 0.45 | 1.50 | 33.08 | 98.13 | 57.97 | 0.0000504 | 4.0402 |
| 9.60 | 7.00 | 0.30 | 1.00 | 78.13 | 161.24 | 97.24 | 0.0000331 | 4.1100 |
| 11.60 | 7.00 | 0.30 | 2.00 | 78.79 | 192.87 | 66.85 | 0.0000479 | 4.1100 |
| 13.60 | 7.00 | 0.30 | 3.00 | 79.59 | 230.48 | 48.85 | 0.0000566 | 4.1100 |
| 6.20 | 3.00 | 0.60 | 1.00 | 15.07 | 55.33 | 55.74 | 0.0000489 | 4.1670 |
| 8.20 | 3.00 | 0.60 | 2.00 | 15.53 | 76.82 | 32.21 | 0.0000622 | 4.1670 |
| 10.20 | 3.00 | 0.60 | 3.00 | 16.11 | 104.28 | 21.10 | 0.0000685 | 4.1670 |
| 9.21 | 5.54 | 0.34 | 1.50 | 49.44 | 124.48 | 68.31 | 0.0000465 | 4.5521 |
| 7.63 | 3.71 | 0.46 | 1.50 | 22.79 | 76.59 | 49.85 | 0.0000540 | 4.7112 |
| 7.60 | 5.00 | 0.30 | 1.00 | 40.13 | 92.87 | 81.54 | 0.0000400 | 5.6578 |
| 9.60 | 5.00 | 0.30 | 2.00 | 40.67 | 118.54 | 51.40 | 0.0000549 | 5.6578 |
| 11.60 | 5.00 | 0.30 | 3.00 | 41.34 | 150.18 | 35.46 | 0.0000628 | 5.6578 |
| 7.20 | 4.60 | 0.30 | 1.00 | 34.04 | 81.49 | 77.60 | 0.0000417 | 6.1188 |
| 9.20 | 4.60 | 0.30 | 2.00 | 34.56 | 105.97 | 47.84 | 0.0000565 | 6.1188 |
| 11.20 | 4.60 | 0.30 | 3.00 | 35.20 | 136.41 | 32.54 | 0.0000642 | 6.1188 |
| 6.60 | 4.00 | 0.30 | 1.00 | 25.85 | 65.86 | 71.03 | 0.0000446 | 6.9710 |
| 8.60 | 4.00 | 0.30 | 2.00 | 26.33 | 88.54 | 42.16 | 0.0000591 | 6.9710 |
| 10.60 | 4.00 | 0.30 | 3.00 | 26.93 | 117.19 | 28.03 | 0.0000663 | 6.9710 |
| 5.60 | 3.00 | 0.30 | 1.00 | 14.71 | 43.61 | 57.97 | 0.0000504 | 9.0792 |
| 7.60 | 3.00 | 0.30 | 2.00 | 15.12 | 63.31 | 31.84 | 0.0000639 | 9.0792 |
| 9.60 | 3.00 | 0.30 | 3.00 | 15.66 | 88.98 | 20.25 | 0.0000699 | 9.0792 |

CABLE PROPERTIES-PART C

| | | | | | | | | |
|---|---|---|---|---|---|---|---|---|
| 5.60 | 3.00 | 0.30 | 1.00 | 14.71 | 43.61 | 57.97 | 0.0000504 | 9.0792 |
| 7.60 | 3.00 | 0.30 | 2.00 | 15.12 | 63.31 | 31.84 | 0.0000639 | 9.0792 |
| 9.60 | 3.00 | 0.30 | 3.00 | 15.66 | 88.98 | 20.25 | 0.0000699 | 9.0792 |
| 6.20 | 3.00 | 0.60 | 1.00 | 15.07 | 55.33 | 55.74 | 0.0000489 | 4.1670 |
| 8.20 | 3.00 | 0.60 | 2.00 | 15.53 | 76.82 | 32.21 | 0.0000622 | 4.1670 |
| 10.20 | 3.00 | 0.60 | 3.00 | 16.11 | 104.28 | 21.10 | 0.0000685 | 4.1670 |
| 8.44 | 3.00 | 0.72 | 2.00 | 15.70 | 82.65 | 32.43 | 0.0000616 | 3.3617 |
| 6.80 | 3.00 | 0.90 | 1.00 | 15.49 | 68.57 | 54.44 | 0.0000475 | 2.5665 |
| 8.80 | 3.00 | 0.90 | 2.00 | 15.98 | 91.85 | 32.83 | 0.0000606 | 2.5665 |
| 10.80 | 3.00 | 0.90 | 3.00 | 16.60 | 121.10 | 22.06 | 0.0000671 | 2.5665 |
| 7.63 | 3.71 | 0.46 | 1.50 | 22.79 | 76.59 | 49.85 | 0.0000540 | 4.7112 |
| 7.96 | 3.96 | 0.50 | 1.50 | 25.88 | 85.28 | 52.29 | 0.0000527 | 4.0401 |
| 6.60 | 4.00 | 0.30 | 1.00 | 25.85 | 65.86 | 71.03 | 0.0000446 | 6.9710 |
| 8.60 | 4.00 | 0.30 | 2.00 | 26.33 | 88.54 | 42.16 | 0.0000591 | 6.9710 |
| 10.60 | 4.00 | 0.30 | 3.00 | 26.93 | 117.19 | 28.03 | 0.0000663 | 6.9710 |
| 7.20 | 4.00 | 0.60 | 1.00 | 26.30 | 80.12 | 67.55 | 0.0000438 | 3.2625 |
| 9.20 | 4.00 | 0.60 | 2.00 | 26.82 | 104.59 | 41.68 | 0.0000578 | 3.2625 |
| 11.20 | 4.00 | 0.60 | 3.00 | 27.46 | 135.03 | 28.38 | 0.0000650 | 3.2625 |
| 7.80 | 4.00 | 0.90 | 1.00 | 26.81 | 95.90 | 65.07 | 0.0000430 | 2.0435 |
| 9.80 | 4.00 | 0.90 | 2.00 | 27.36 | 122.17 | 41.51 | 0.0000565 | 2.0435 |
| 11.80 | 4.00 | 0.90 | 3.00 | 28.04 | 154.40 | 28.88 | 0.0000638 | 2.0435 |
| 8.40 | 4.50 | 0.45 | 1.50 | 33.08 | 98.13 | 57.97 | 0.0000504 | 4.0402 |
| 9.00 | 4.50 | 0.75 | 1.50 | 33.63 | 115.32 | 56.36 | 0.0000494 | 2.2883 |
| 7.20 | 4.60 | 0.30 | 1.00 | 34.04 | 81.49 | 77.60 | 0.0000417 | 6.1188 |
| 9.20 | 4.60 | 0.30 | 2.00 | 34.56 | 105.97 | 47.84 | 0.0000565 | 6.1188 |
| 11.20 | 4.60 | 0.30 | 3.00 | 35.20 | 136.41 | 32.54 | 0.0000642 | 6.1188 |
| 7.80 | 4.60 | 0.60 | 1.00 | 34.55 | 97.28 | 73.64 | 0.0000412 | 2.8867 |
| 9.80 | 4.60 | 0.60 | 2.00 | 35.10 | 123.55 | 46.94 | 0.0000554 | 2.8867 |

CABLE PROPERTIES-PART D

| | | | | | | | | |
|---|---|---|---|---|---|---|---|---|
| 11.80 | 4.60 | 0.60 | 3.00 | 35.78 | 155.78 | 32.63 | 0.0000630 | 2.8867 |
| 10.04 | 4.60 | 0.72 | 2.00 | 35.33 | 131.00 | 46.68 | 0.0000550 | 2.3522 |
| 8.40 | 4.60 | 0.90 | 1.00 | 35.10 | 114.59 | 70.68 | 0.0000406 | 1.8210 |
| 10.40 | 4.60 | 0.90 | 2.00 | 35.69 | 142.65 | 46.39 | 0.0000543 | 1.8210 |
| 12.40 | 4.60 | 0.90 | 3.00 | 36.41 | 176.67 | 32.87 | 0.0000619 | 1.8210 |
| 8.60 | 4.60 | 0.50 | 1.50 | 34.65 | 103.94 | 58.63 | 0.0000498 | 3.5359 |
| 7.60 | 5.00 | 0.30 | 1.00 | 40.13 | 92.87 | 81.54 | 0.0000400 | 5.6578 |
| 9.60 | 5.00 | 0.30 | 2.00 | 40.67 | 118.54 | 51.40 | 0.0000549 | 5.6578 |
| 11.60 | 5.00 | 0.30 | 3.00 | 41.34 | 150.18 | 35.46 | 0.0000628 | 5.6578 |
| 8.20 | 5.00 | 0.60 | 1.00 | 40.67 | 109.68 | 77.34 | 0.0000396 | 2.6808 |
| 10.20 | 5.00 | 0.60 | 2.00 | 41.25 | 137.14 | 50.27 | 0.0000539 | 2.6808 |
| 12.20 | 5.00 | 0.60 | 3.00 | 41.95 | 170.56 | 35.38 | 0.0000618 | 2.6808 |
| 10.44 | 5.00 | 0.72 | 2.00 | 41.49 | 145.00 | 49.92 | 0.0000535 | 2.1879 |
| 8.80 | 5.00 | 0.90 | 1.00 | 41.26 | 128.01 | 74.13 | 0.0000392 | 1.6977 |
| 10.80 | 5.00 | 0.90 | 2.00 | 41.88 | 157.26 | 49.48 | 0.0000529 | 1.6977 |
| 12.80 | 5.00 | 0.90 | 3.00 | 42.62 | 192.48 | 35.46 | 0.0000607 | 1.6977 |
| 9.03 | 5.12 | 0.46 | 1.50 | 42.54 | 117.80 | 63.63 | 0.0000478 | 3.5359 |
| 9.21 | 5.54 | 0.34 | 1.50 | 49.44 | 124.48 | 68.31 | 0.0000465 | 4.5521 |
| 9.60 | 7.00 | 0.30 | 1.00 | 78.13 | 161.24 | 97.24 | 0.0000331 | 4.1100 |
| 11.60 | 7.00 | 0.30 | 2.00 | 78.79 | 192.87 | 66.85 | 0.0000479 | 4.1100 |
| 13.60 | 7.00 | 0.30 | 3.00 | 79.59 | 230.48 | 48.85 | 0.0000566 | 4.1100 |
| 10.20 | 7.00 | 0.60 | 1.00 | 78.84 | 183.13 | 92.45 | 0.0000333 | 1.9764 |
| 12.20 | 7.00 | 0.60 | 2.00 | 79.54 | 216.56 | 64.86 | 0.0000473 | 1.9764 |
| 14.20 | 7.00 | 0.60 | 3.00 | 80.37 | 255.95 | 48.09 | 0.0000559 | 1.9764 |
| 10.80 | 7.00 | 0.90 | 1.00 | 79.60 | 206.55 | 88.51 | 0.0000333 | 1.2686 |
| 12.80 | 7.00 | 0.90 | 2.00 | 80.34 | 241.77 | 63.24 | 0.0000468 | 1.2686 |
| 14.80 | 7.00 | 0.90 | 3.00 | 81.20 | 282.95 | 47.51 | 0.0000552 | 1.2686 |

The cable can have a weight per unit length of between 80 kg/km and 150 kg/km.

The cable can have a weight per unit length of between about 80 kg/km and about 145 kg/km.

Preferably, the cable can have a weight per unit length between about 80 kg and about 120 kg/km.

The DC resistance of the cable depends mainly on the cross-sectional area of the aluminium layer. This depends on the diameter and thickness of the aluminium. The diameter of the aluminium is determined by the diameter of the core. Thus, compared with a smaller core diameter, a larger core diameter permits a thinner aluminium layer to be used for the same current carrying capacity.

From Table 1, the cable designs can encompass the following range of properties:

TABLE 2

| | | | Thicknesses (for minimum | | | Thicknesses (for maximum | | |
|---|---|---|---|---|---|---|---|---|
| | | | diameter) mm | | | diameter) mm | | |
| | | | Core | | XLPE/ | Core | | XLPE/ |
| | Min | Max | (diameter) | Aluminium | . . . | (diameter) | Aluminium | . . . |
| Overall | 5.60 | 14.80 | 3.00 | 0.30 | 1.00 | 7.00 | 0.90 | 3.00 |
| diameter | | mm | | | | | | |
| UTS | 14.71 | 81.20 | 3.00 | 0.30 | 1.00 | 7.00 | 0.90 | 3.00 |
| | | kN | | | | | | |
| Weight | 43.61 | 282.95 | 3.00 | 0.30 | 1.00 | 7.00 | 0.90 | 3.00 |
| | | kg/km | | | | | | |
| Resistance | 1.269 | 9.079 | 7.00 | 0.90 | 1.00 | 3.00 | 0.30 | 3.00 |
| | | ohm/km | | | | | | |

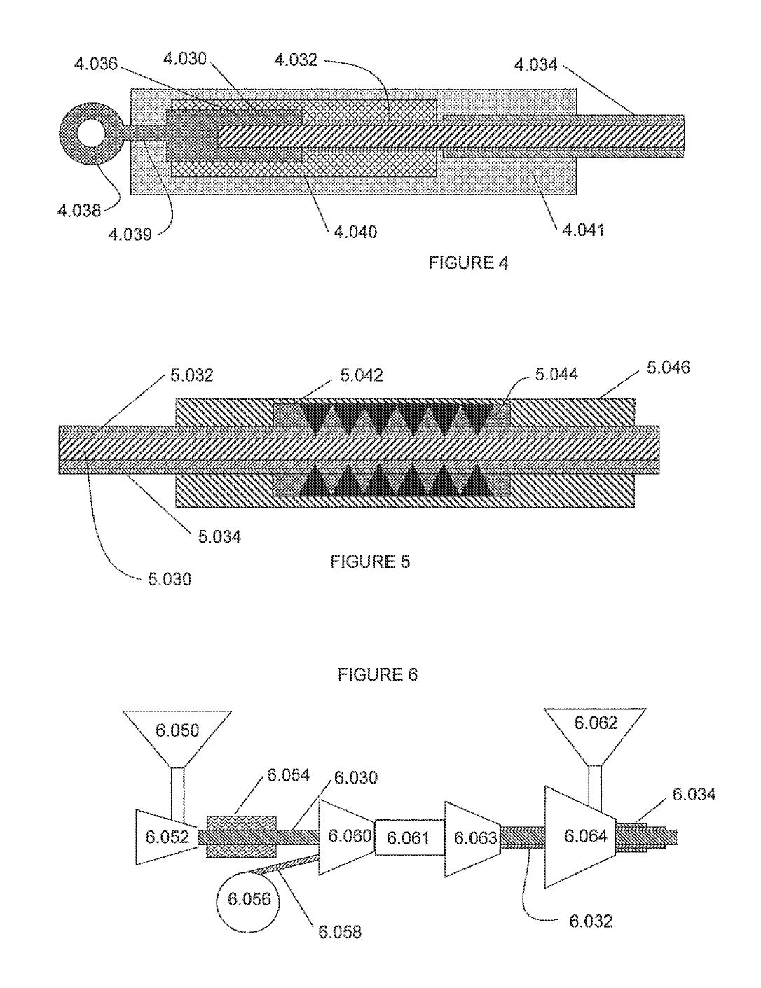

The cable can be dimensioned to be compatible with existing terminations and connections. FIG. 4 illustrates a dead end connection connected to a cable according to an embodiment of the invention. The dead end connection includes a first compression clamp 4.036 attached to a dead end eye bolt 4.038.

The core 4.030 can be dimensioned to cooperate with the compression clamp 4.036. A second compression clamp 4.040 cooperates with the electrically conductive layer 4.032 and the first compression clamp 4.036 to establish electrical connection between the conductive layer 4.032 and the first compression clamp 4.306. A heat shrink fitting 4.041 can be applied over the assembly, leaving the dead end eye free.

To make a dead end connection, the cable insulation 4.034 is removed to a sufficient length to expose a sufficient length of the conductive layer 4.032 to be contacted by the second compression clamp 4.040. Then a length of the exposed conductive layer 4.032 is removed to operatively engage the first compression clamp 4.036. The heat shrink sleeve 4.041, the second compression clamp 4.038 can be fed onto the cable in turn before the dead end connection is clamped to the core 4.030. After the first compression clamp 4.036 is clamped to the core 4.030, the second compression clamp 3.040 is slid over the exposed section of the conductive layer 4.032 and the first compression clamp 4.036 and clamped to provide an electrical and mechanical connection between the conductive layer 4.032 and the first compression clamp 4.036. The heat shrink sleeve 4.041 is then slid into place over the insulation layer 4.034, the second compression clamp 4.040 and the dead end connector, leaving part of the neck 4.041 of the dead end connector and the dead end eye 4.038 exposed. The heat shrink sleeve is then shrunk to close around the cable end and the neck 4.041 and first compression clamp 4.036.

Alternatively, the cable can be terminated with a standard helical strain fitting gripping a length of the outer jacket of the cable, in which case, the end of the cable can be sealed. A commercially available insulation piercing connector can be used to connect to the conductor to provide the electrical termination.

An intermediate electrical connection can be made using an insulation piercing connector as shown in FIG. 5. A connector 5.042 has a plurality of insulation piercing elements 5.044 which are forced through the insulation layer 5.034 to make electrical contact with the conductive layer 5.032 when the connector is crimped onto the cable. A heat shrink cover 5.046 is applied over the connector 5.042 and the adjacent portions of the cable jacket 5.034.

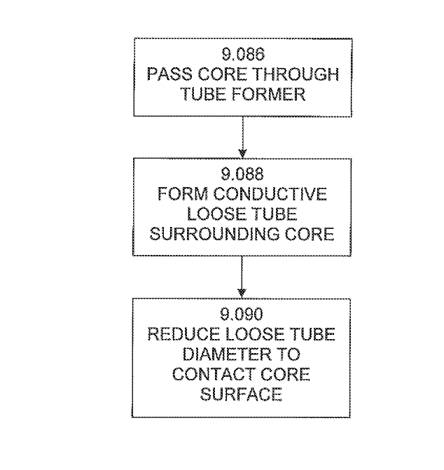

As illustrated in the flow diagram of FIG. 8, the cable is manufactured using three main stages. In a first stage 8.080, the composite core is manufactured. In a second stage 8.082, the conductive layer is applied to the core. In a third stage 8.084, the external jacket is applied over the conductive layer. Additional and alternative steps for one or more of the stages will be described below.

FIG. 6 illustrates a first production line for manufacturing a cable according to an embodiment of the invention.

Material for the composite core is fed from a feeder, shown for illustrative purposes as bin 6.050, to a first extrusion station 6.052. The extruded core 6.030 is then fed through a conductor application station 6.060, optionally via a cooling bath 6.054. Conductive tape 6.058 is supplied from a spool 6.056 and wrapped around the core in the application station to form a loose tube. A jointing station 6.061 can be included to join the longitudinal sides of the tape to produce close circumference loose tube. The loose tube is then drawn down at stage 6.063 to contact the outer surface of the core and produce the conductive layer 6.032 on the core 6.030. The assembled core and conductive layer are then fed to a jacketing station 6.064 where an external jacket 6.034 is applied over the conductive layer by extrusion.

Alternatively, an aluminium tape can be wrapped helically around the core and the outer layer extruded over the aluminium tape.

In a further embodiment, a tape wrapped around the core can be welded in place on the surface of the core, as the small thickness of the aluminium requires only a small amount of heat which is insufficient to damage the core.

Each of the three components of the cable can be manufactured in separate stages. The core 6.030 can be manufactured and supplied to the conductive layer application stage 6.060, 6.061, 6.063 from a spool. Similarly the combined core and conductive layer can be supplied to the jacketing stage 6.064 from a spool.

Where a conductor layer with increased thickness is required, the core with a first conductive layer can be passed through the conductive layer application stage a second time before the jacket is applied.

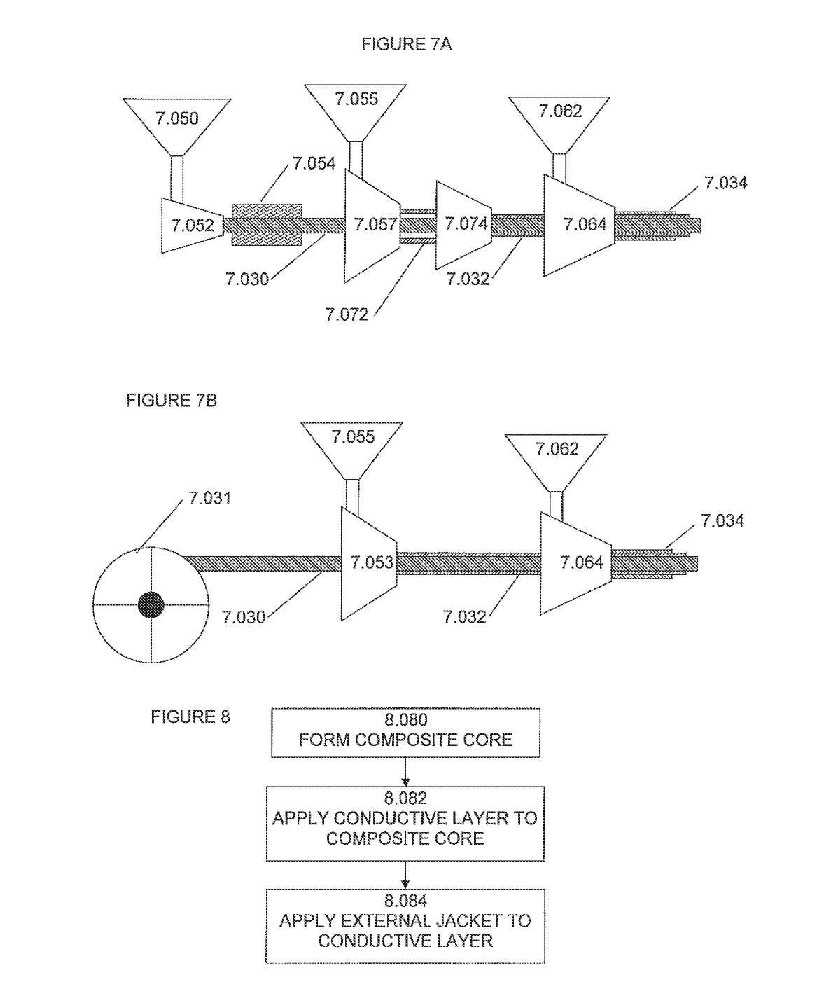

FIG. 7A illustrates an alternative production line. The core 7.030 is produced in the first extrusion station 7.050/7.052 as discussed above in relation to FIG. 6. The conductive layer is made in a continuous forming process. A supply of conductive material is provided as shown illustratively by bin 7.055. At the tube forming station 7.057, a loose conductive tube 7.072 is formed around the core 7.030. A cooling bath, not shown, can be included between the tube forming station 7.057 and a reduction station 7.074. At stage 7.074, the loose tube 7.072 is drawn down to contact the surface of the core 7.030, thus forming the conductive layer 7.032. At extrusion station 7.062/7.064, the jacket 7.034 is applied over the conductive layer 7.032 in a similar manner to that described with reference to FIG. 6.

FIG. 7B shows alternative embodiment, in which the tube forming station 7.054 and the reduction station 7.074 are replaced by an extrusion station 7.053. The core 7.030 is supplied from spool 7.031. The conductive layer 7.032 is extruded directly onto the surface of the core. This process eliminates the need for the intermediate steps of forming a loose tube and drawing the loose tube down to the surface of the core.

Again, the core, the clad core, and the jacketed cable can be manufactured in separate stages.

FIG. 9 shows details of one method of performing stage 8.082. This method can be implemented using the production line of FIG. 7.

At stage 9.086, the core 7.030 is passed through the tube forming station. At step 9.088, the tube forming station 7.057 forms the loose tube 7.072 surrounding the core 7.030. At step 9.090, the diameter of the loose tube is reduced so the conductive layer is in contact with the surface of the core. The jacket is then applied as described above.

The core is designed to have a suitable strength to weight ratio which enables cables of equivalent or smaller diameter to be used in applications where aluminium/steel cables are currently used.

The core is preferably made of carbon fibres in an epoxy matrix. The ratio of fibre to matrix can be in the order of 30/70 to 70/30. Preferably, the ratio can be between about 40/60 to 60/40.

In one embodiment, the composite core has the following properties: density 1.65 g/cm3, thermal elongation 2×10-6, modulus of elasticity 155 GPa, UTS 1400 MPa minimum, and the outer jacket of XLPE has the following properties: density 0.946, thermal elongation 80, modulus of elasticity ˜0.8 GPa, UTS 25 MPa).

### Example 1

A first cable configuration using these materials has the following dimensions and characteristics:

3.6 mm diameter composite core;
0.462 mm thick aluminium (5.92 mm2);
1.0 mm thick XLPE/HDPE;
Total diameter: 6.52 mm;
Mass: 59.19 kg/km;
Breaking load: 23.27 kN

### Example 2

A second cable using the same materials can have the following dimensions and characteristics: 4.65 mm diameter composite core;

0.375 mm thick aluminium (5.92 mm2);
2.3 mm thick XLPE/HDPE;
Total diameter: 10 mm;
Mass: 120.5 kg/km;
Breaking load: 25.42 kN;

Example 1 has a lower wind loading due to the lower outer diameter.

A cable made according to the invention has the advantage of having only three components, a core, a conductive layer, and a jacket. In addition, cables made according to the present invention have a higher strength to weight ratio than current aluminium steel cables. The cable also has good flexibility suitable for application as a suspended power line.

While the cable of this invention has been described in the context of a SWER line rural application, the cable can also be adapted use in other areas. For example, in suburban applications where the lines may come in contact with trees, the cable can be used in a 3 phase application. For such an application, the distance between poles will usually be substantially shorter than for many SWER applications. Thus the outer diameter can be increased to allow for the conductive layer having a greater radius. Also the insulation thickness may be increased.

In this specification, reference to a document, disclosure, or other publication or use is not an admission that the document, disclosure, publication or use forms part of the common general knowledge of the skilled worker in the field of this invention at the priority date of this specification, unless otherwise stated.

In this specification, terms indicating orientation or direction, such as “up”, “down”, “vertical”, “horizontal”, “left”, “right” “upright”, “transverse” etc. are not intended to be absolute terms unless the context requires or indicates otherwise. These terms will normally refer to orientations shown in the drawings.

In this specification, “device” can include one or more separate physical components.

Where ever it is used, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

It will be understood that the invention disclosed and defined herein extends to all alternative combinations of two or more of the individual features mentioned or evident from the text. All of these different combinations constitute various alternative aspects of the invention.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, and all modifications which would be obvious to those skilled in the art are therefore intended to be embraced therein.

1. An electrical cable comprising:
including a core made from a material having high tensile strength,
a conductive layer over the core, and
an outer jacket.

2. A cable as claimed in claim 1, wherein the conductive layer is a tube the inner diameter of which is in contact with the outer surface of the core.

3. A cable as claimed in claim 1, wherein the conductive layer is aluminium.

4. A cable as claimed in claim 1, wherein the outer jacket is made from a material having electrical insulating properties.

5. A cable as claimed in claim 1 having an outer diameter of about 13 mm or less.

6. A cable as claimed in claim 1, wherein the outer diameter of the cable is no greater than 10 mm.

7. A cable as claimed in claim 1, wherein the core has a diameter of between about 3 mm and about 8 mm.

8. A cable as claimed in claim 8, wherein the core diameter is greater than or equal to about 3.5 mm and the less than or equal to about 7 mm.

9. A cable as claimed in claim 1, wherein the thickness of the conductive layer is no greater than about 2 mm and no less than about 0.2 mm.

10. A single line earth return line including a cable as claimed in claim 1.

11. An overhead power line including at least one line having a cable as claimed in claim 1.

12. A method of manufacturing a suspension cable, the method including the steps of:
applying a layer of conductive material to the exterior of a core,
and applying a jacket over the layer of conductive material.

13. A method of manufacturing a cable as claimed in claim 12, wherein the step of applying a layer of conductive material includes the step of wrapping a tape of conductive material around the core.

14. A method as claimed in claim 13, including the steps of bonding the longitudinal sides of the tape together after the tape is wrapped around the core to form a loose tube around the core, and drawing the loose tube down to the outer surface of the core.

15. A method of manufacturing a cable as claimed in claim 12, including the steps of forming a loose tube of conductive material around the core in a continuous forming process, and drawing the loose tube down to contact the surface of the core.

16. A method of manufacturing a cable as claimed in claim 12, wherein the step of applying a layer of conductive material to the core includes the step of extruding the conductive layer onto the core.
